(19) United States
(12) Patent Application Publication
(10) Pub. No.: US 2017/0215224 A1
(43) Pub. Date: Jul. 27, 2017

(54) A METHOD AND APPARATUS FOR MAINTENANCE AND RELEASE OF UE RESOURCES

(71) Applicant: Samsung Electronics Co., Ltd., Suwon-si, Gyeonggi-do (KR)

(72) Inventors: Xiaowan KE, Beijing (CN); Lixiang XU, Beijing (CN); Hong WANG, Beijing (CN)

(21) Appl. No.: 15/115,109

(22) PCT Filed: Jan. 29, 2015
(86) PCT No.: PCT/KR2015/000986

§ 371 Date: Jul. 28, 2016

(30) Foreign Application Priority Data
Jan. 29, 2014 (CN) 201410043758.3

(51) Int. Cl. H04W 76/06; H04W 8/00; H04W 76/04; H04W 4/00

(52) U.S. Cl. CPC H04W 76/062; H04W 4/008; H04W 8/005; H04W 76/043

(57) ABSTRACT

The present disclosure provides a method for maintenance and release of UE resources. A UE that transmits signals requests release of radio resources configured to the UE. A radio network node releases radio resources configured to the UE for proximity-based service (ProSe).

### TECHNICAL FIELD

The present disclosure relates to radio communications, and particularly, to a method and apparatus for maintenance and release of UE resources.

### BACKGROUND ART

Mobile communications techniques are providing more and more diversified services. Currently, U.S.A. public safety departments have deployed LTE networks as basic communications networks for their public safety communication services. Proximity-based services (ProSe) between/among UEs form an indispensable part of public safety communications services, and include ProSe direct discovery among UEs and ProSe direct communication among UEs. ProSe direct discovery among UEs may be the basis of ProSe direct communication among UEs. ProSe direct discovery among UEs can detect existence of UEs of friends, and can prompt users to take further actions. When applied to public safety, the ProSe direct discovery/communication among UEs can assist public safety personnel in mission control and cooperation in specific outfield environment, and security is provided via a confidential way. The ProSe services also have flexible applications in a commerce field. In particular, a field social network can be fast formed. For example, proximate users having a same interest can discover each other, or can push a commerce advertisement to each other.

### DISCLOSURE OF INVENTION

### Technical Problem

The method for resources maintenance and release of proximity based services among UEs according to the present disclosure involves a role of transmission UE and a role of monitoring UE in a direct discovery process. The monitoring UE monitors information transmitted by a nearby transmission UE to discover and identify the nearby UE or user. In the scenario of in coverage of network, radio resources of a transmission UE are configured by the network. The resources may be configured using an allocation type 1, i.e., configured radio resources are shared by all of UEs or by a group of UEs which contend with each other for the shared radio resources. Alternatively, the resources may be configured using an allocation type 2, i.e., each UE is configured with dedicated resources. Radio resources that have been configured to UE for the direct discovery service should be managed and scheduled by the network to avoid interferences between UE-to-UE services and UE-to-network services. The resource allocation for direct communication service also has two types: mode1 and mode2. For mode1, each UE or each UE group is configured with dedicated resources. For mode2, the configured radio resources are shared by UEs. With respect to dedicated resources configured to a UE or a group of UEs, the network need to maintain relationships between the dedicated resources and the UE or the group of UEs, e.g., the relationships are generally saved in context information of the UE or of the group of UEs.

In legacy 3GPP network versions, the release of radio resources configured to a UE and the release of an RRC connection of a UE are both initiated by the network. The network stores the context of a UE only when the UE is in an RRC-connected state. The context refers to UE-related bearer information, e.g., dedicated resources configured to a UE, and the like. Processes of releasing RRC connections are initiated by the network. For example, when a RRC connected UE is in an inactive state and has no data exchange with the network within a long time, the network may decide to initiate an RRC release process and delete information related to the UE, e.g., context of the UE. When a UE is processing direct discovery service or direct communication service, information is directly transmitted and monitored among UEs without being delivered over the network. According to the legacy network design, after a time period during which the UE has no data change with the network, the network may initiate the process of releasing the RRC connection between the UE and the network, the UE returns to an idle state, and a radio network node directly deletes the context of the UE. If the ProSe service of the UE is still ongoing with the configured radio resource, the network will be unable to identify the radio resources is occupied by which UE if the UE context is deleted, and the network cannot decide whether those radio resources are available to be configured to other UEs or other services. If the ProSe radio resource configured for UE is also removed when the RRC connection between the UE and the network is released, the ongoing ProSe service on UE has to be interrupt. Furthermore, if the UE terminates ProSe Service on UE, the radio resource configured for ProSe Service on UE is not useful any more, but eNB has no idea about what happen on UE and still reserve the dedicated radio resource configured for the ProSe service of the UE. Therefore, the legacy 3GPP process for releasing radio resources and UE context is not suitable for ProSe.

### Solution to Problem

The present disclosure provides a method and apparatus for maintenance and release of UE resources to correctly release radio resources configured to UEs for proximity based services.

The present disclosure provides the following technical mechanisms.

A method for maintenance and release of UE resources may include:

releasing, by a first radio network node which configured radio resources for a ProSe of a first UE that transmits signals, the radio resources configured to the first UE for the ProSe or deleting ProSe context of the first UE according to a radio resources release request sent by the first UE in the ProSe or according to an instant state of the first UE; wherein the ProSe is a ProSe direct discovery service or a ProSe direct communication service.

In an example, the procedure of the first radio network node releases the radio resources or deletes the ProSe context according to the radio resources release request sent by the first UE in the ProSe may include:

if the first radio network node is not a second radio network node that is currently serving the first UE, the second radio network node receives the radio resources release request or a radio resources configuration request sent by the first UE which specifies an identity or an address of the first radio network node, and sends a resources release request to the first radio network node managing the radio resources via an S1 interface or an X2 interface, the resources release request specifies an identity of the first UE, an identity of the ProSe of the first UE or an identity of the radio resources requested to be released; the first radio network node releases the radio resources or deletes the ProSe context;

if the first radio network node is the second radio network node that is serving the first UE, the first radio network node receives the radio resources release request sent by the first UE, the first radio network node releases the radio resources identified by the radio resources release request or deletes the ProSe context.

In an example, the procedure of the first radio network node releases the radio resources or deletes the ProSe context according to the radio resources release request sent by the first UE in the ProSes may include:

a core network node receives the radio resources release request sent by the first UE, instructs the first radio network node to release the radio resources or delete the ProSe context, and the radio network node that configured the radio resources releases the radio resources or deletes the ProSe context.

In an example, the procedure of the radio network node that configured the radio resources releases the radio resources or deletes the ProSe context according to the radio resources release request sent by the first UE in the ProSes may include:

a ProSe server (ProSe function) receives the radio resources release request or a ProSe termination request sent by the first UE, instructs the first radio network node via a core network node to release the radio resources or delete the ProSe context, and the first radio network node releases the radio resources or deletes the ProSe context.

In an example, the resources release request sent by the first UE includes an identity of the first UE, an identity of the ProSe and/or an identity or an address of the first radio network node.

In an example, the method may also include: after the first radio network node released the radio resources, the first radio network node informs an MME that the radio resources or the ProSe context of the first UE has been released, and the MME informs the ProSe function that the radio resources or the ProSe context of the first UE has been released.

In an example, the procedure of the first radio network node releases the radio resources or deletes the ProSe context according to an instant state of the first UE may include:

after the first UE is handed over from a serving radio network node to a target radio network node and the target radio network node re-configures radio resources for the ProSe of the first UE, or after the first UE moves from the serving radio network node to the target radio network node and requests the target radio network node to reconfigure radio resources for the ProSe of the first UE, the serving radio network node receives a UE context release command or a resources release command sent by the target radio network node via an X2 interface or from a core network node via an S1 interface, and releases the ProSe context or the radio resources of the first UE;

the method may also include: after the serving radio network node released the radio resources, the target radio network node sends a resource update notification to a core network node, the core network node sends the resource update notification to the ProSe function; the resource update notification includes: the resources of the ProSe of the first UE is changed from the serving radio network node/serving cell to the target radio network node/target cell.

In an example, the method may also include: before the first radio network node releases the radio resources or deletes the ProSe context, the first radio network node configures in the first UE a ProSe state report which includes a periodicity of the state report; the first UE feeds back the state report to the first radio network node according to the periodicity of the state report; the first radio network node keeps the first UE in an RRC connected state if the state report is received within a pre-set time period;

the procedure of the first radio network node releases the radio resources of the first UE in the ProSe according to the instant state of the first UE may include:

if the first radio network node does not receive the state request within the pre-set time period, the first radio network node directly releases the radio resources or deletes the ProSe context, or requests a core network node to release the radio resources and releases the radio resources or deletes the ProSe context after receiving a radio resources release command from the core network node, or requests the ProSe function via the core network node to release the radio resources and releases the radio resources or deletes the ProSe context after receiving an instruction of releasing the radio resources sent by the ProSe function via the core network node.

In an example, the first radio network node performs the configuration of the state report when allocating resources for the ProSe of the first UE for or before the process of releasing the ProSe context of the first UE is triggered when no data is exchanged between the first UE and the network.

In an example, the method may also include: before the first radio network node releases the radio resources, the first radio network node pages the first UE before the process of deleting the ProSe context of the first UE is triggered when no data is exchanged between the first UE and the network, and keeps the first UE in the RRC connected state if a response is received from the first UE within a pre-set number of paging times or within a pre-set response time limit;

the procedure of the first radio network node releases the radio resources of the first UE in the ProSe according to the instant state of the first UE may include: if a paging response is not received from the first UE after a pre-set number of times of paging or within a pre-set paging response time limit, the first radio network node directly releases the radio resources or deletes the ProSe context, or requests the core network node to release the radio resources and releases the radio resources or deletes the ProSe context after receiving a radio resources release instruction from the core network node, or requests the ProSe function via the core network node to release the radio resources and releases the radio resources or deletes the ProSe context after receiving an instruction for releasing the radio resources from the ProSe function via the core network node.

In an example, the method may also include: after the first radio network node released the radio resources or deleted the ProSe context, the first radio network node informs a core network node that the radio resources or the ProSe context has been released, and the core network node informs the ProSe function that the radio resources or the ProSe context has been released.

In an example, when releasing the radio resources or deleting the ProSe context, if the first UE is a member of a UE group, the first radio network node deletes the ProSe context, reserving the resources requested to be released until the first UE is the last member of the UE group.

In an example, the radio resources are radio time/frequency resources.

In an example, the method may also include: after the radio resources are released or the ProSe context is deleted, the first radio network node instructs a second UE that is monitoring signals in the same cell with the first UE to update monitor configurations via system broadcast signaling of the ProSe or via RRC signaling.

In an example, the method may also include: before the radio resources are released, the first radio network node sends radio resources of UEs that are transmitting signals and monitor configurations of UEs that are monitoring signals served by the first radio network node to adjacent radio network nodes of the first radio network node; an adjacent radio network node configures monitor configurations in UEs that are monitoring signaling within an area served by the adjacent radio network node; and

the method may also include: after the radio resources of the first UE are deleted, the first radio network node sends resources update information to the adjacent radio network node, and the adjacent radio network node determines whether to update the monitor configurations of the UEs that are monitoring signals within the area served by the adjacent radio network node.

A method for maintenance and release of UE resources may include:

instructing, by a UE that is transmitting signals in a ProSe, a first radio network node that configured radio resources to the UE for the ProSe directly or via a core network node or via the core network node and a ProSe server (ProSe function) to release the radio resources for the ProSe or to delete ProSe context of the UE; the ProSe is a ProSe direct discovery service or a ProSe direct communication service;

when the UE informs the first radio network node indirectly, a radio resources release request sent by the UE includes an identity or an address of the first radio network node.

In an example, the procedure of the UE directly instructing the first radio network node may include: when the first radio network node that configured the radio resources is a second radio network node that is serving the UE, the UE sends a radio resources release request directly to the first radio network node to request the first radio network node to release the radio resources for the ProSe; when the first radio network node is not the second radio network node that is serving the UE, the UE sends a radio resources release request directly to the second radio network node, the second radio network node instructs the first radio network node that configured the radio resources via an S1 interface or an X2 interface to release the radio resources for the ProSe;

the procedure of the UE instructs the first radio network node via the core network node may include: the UE sends a radio resources release request to the core network node, and the core network node instructs the first radio network node to release the radio resources;

the procedure of the UE instructs the first radio network node via the core network node and the ProSe function may include: the UE sends a radio resources release request or a ProSe termination request to the ProSe function, the ProSe function instructs the first radio network node via the core network node to release the radio resources.

A radio network node apparatus may include a resources release initiating module and a resources releasing module;

the resources release initiating module is configured to instruct the resources releasing module to release resources according to a radio resources release request sent by a UE that is transmitting signals in a ProSe or according to an instant state of the UE;

the resources releasing module is configured to release radio resources configured to the UE for the ProSe or delete ProSe context of the UE after receiving a trigger signal from the resources release initiating module.

the ProSe is a ProSe direct discovery service or a ProSe direct communication service.

A user equipment may include: a resources release decision making module and a release request sending module;

the resource release decision making module is configured to inform the release request sending module when a ProSe is terminated or radio resources for the ProSe is inactivated;

the release request sending module is configured to instruct a radio network node that configured the radio resources directly or via a core network node or via the core network node and a ProSe function to release the radio resources for the terminated or deactivated ProSe after receiving a resources release notification sent by the resources release decision making module;

the ProSe is a ProSe direct discovery service or a ProSe direct communication service; when the UE informs the radio network node indirectly, a radio resources release request sent by the UE includes an identity or an address of the radio network node.

According to the above technical mechanisms, the method and apparatus of the present disclosure enables correct release of radio resources configured to a UE or a group of UEs for a ProSe, and solves the problem of maintenance of ProSe context of UEs. The technical mechanisms provide different solutions regarding resources releasing, state updating, resources switching, monitor configurations updating. The present disclosure provides flexible solutions for ProSe direct discovery services, provide users with diversified network experiences, and can meet requirements for communication services involving public safety and social networking.

### BRIEF DESCRIPTION OF DRAWINGS

FIG. 1 is a schematic diagram illustrating a network structure capable of implementing a method for maintenance and release of UE resources in accordance with an example of the present disclosure;

FIG. 2 is a flowchart illustrating a method for maintenance and release of UE resources in accordance with an example of the present disclosure;

FIG. 3 is a schematic diagram illustrating a method for maintenance and release of UE resources in accordance with example one of the present disclosure;

FIG. 4 is a schematic diagram illustrating a method for maintenance and release of UE resources in accordance with example two of the present disclosure;

FIG. 5 is a schematic diagram illustrating a method for maintenance and release of UE resources in accordance with example three of the present disclosure;

FIG. 6 is a schematic diagram illustrating a method for maintenance and release of UE resources in accordance with example four of the present disclosure;

FIG. 7 is a schematic diagram illustrating a method for maintenance and release of UE resources in accordance with example five of the present disclosure;

FIG. 8 is a schematic diagram illustrating a method for maintenance and release of UE resources in accordance with example six of the present disclosure;

FIG. 9 is a schematic diagram illustrating a method for maintenance and release of UE resources in accordance with example seven of the present disclosure;

FIG. 10 is a schematic diagram illustrating a method for maintenance and release of UE resources in accordance with example eight of the present disclosure;

FIG. 11 is a schematic diagram illustrating a basic structure of a radio network node apparatus in accordance with an example of the present disclosure;

FIG. 12 shows a schematic diagram of a basic structure of a terminal device in accordance with an example of the present disclosure; and

FIG. 13 is a schematic diagram illustrating a basic structure of a core network node apparatus in accordance with an example of the present disclosure.

### MODE FOR THE INVENTION

In order to make the objectives, technical schemes and merits of the present invention clearer, a detailed description of the present invention is hereinafter given with reference to specific embodiments.

The following description takes an eNB as an example of a radio network node, an MME as an example of a core network node.

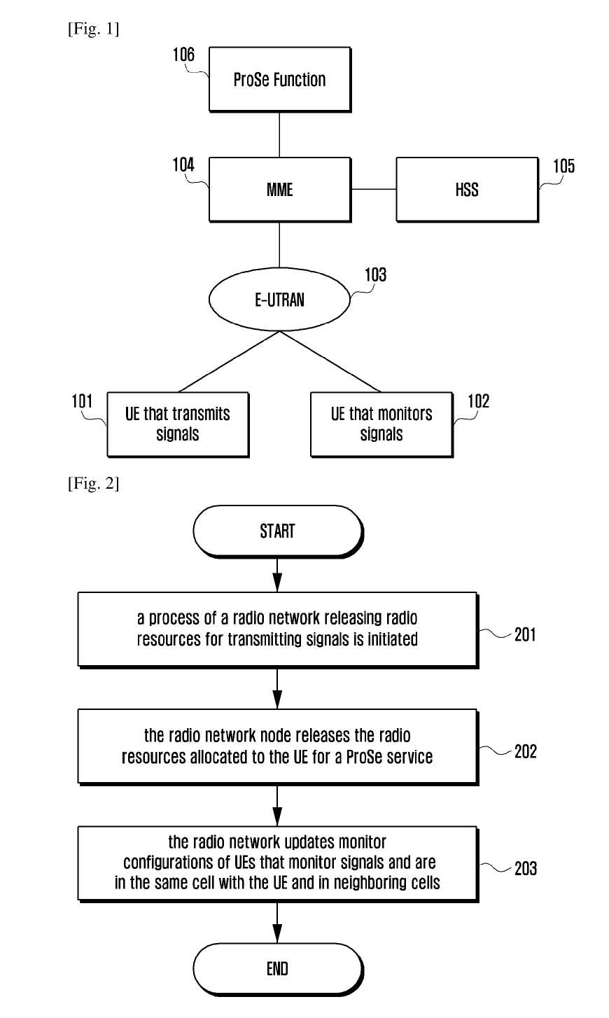

FIG. 1 is a schematic diagram illustrating a network structure capable of implementing a method for maintenance and release of UE resources in accordance with an example of the present disclosure.

As shown in FIG. 1, a user equipment (UE) 101 that transmits signals is a terminal device that transmits signals in a ProSe service. UE 103 that monitors signals is a terminal device that monitors signals transmitted by UEs that transmit signals in a ProSe service. A UE may be a UE that transmits signals and a UE that monitors signals at the same time. Evolved universal terrestrial radio access network (E-UTRAN) 103 is a radio access network, and includes a base station (eNodeB). The eNodeB provides an access interface for UEs to access the radio network, controls resources allocation of UE 101 that transmits signals in the ProSe, and controls monitoring configurations of UE 102 in the ProSe. The mobility management entity (MME) 104 is for managing mobility context, session context and security information of UEs. The home subscriber server (HSS) 105 is a home sub system of UEs, is for storing user information including current location, the address of the serving node, user security information, packet data context of a UE, and access service subscription information of users. The ProSe server for subscriber (PSS, also referred to as ProSe function) 106 is for storing user information such as the user device currently being used by the user of the ProSe, a discovery identity used by the user, security information of the ProSe of the user, ProSe context of the user and the like. The ProSe function may be a standalone node or a standalone system, or may be deployed in the HSS or in the MME.

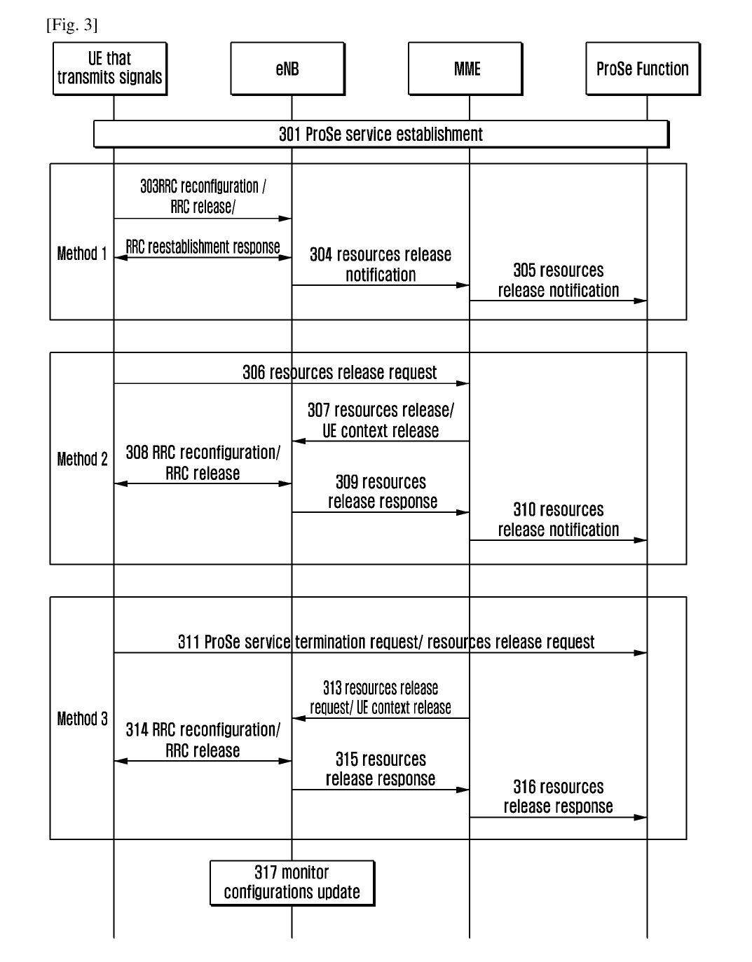

FIG. 2 is a flowchart illustrating a method for maintenance and release of UE resources in accordance with an example of the present disclosure.

At block 201, a process of releasing radio resources configured to a UE that transmits signals in a radio network node is initiated according to a radio resources release request sent by the UE or according to an instant state of the UE. The UE that transmits signals refers to a UE that transmits information in a ProSe service. The information may be information for ProSe direct discovery or information for ProSe direct communication.

In an example, there are five approaches to trigger the release of radio resources of the UE that transmits signals.

1. The UE that transmits signals requests the radio network node to release the radio resources configured to the UE.

In an example, the UE may initiate a request to request the radio network node to release the radio resources configured for ProSe service to the UE. The ProSe may be a ProSe direct discovery service or a ProSe direct communication service.

The radio network node to which the request of the UE is sent may be, or may not be, the radio network node that is serving the UE.

In an example, if the radio network node that is serving the UE is not the radio network node which the UE requests to release the radio resources (i.e., the radio network node that configured the radio resources to be released), the UE may inform the serving radio network node of the identity or the address of the radio network node which is requested to release the radio resources. The serving radio network node may send a resources release request to the requested radio network node and specify the identity of the UE or the identity of the radio resources requested to be released or the identity of the ProSe. In the following situations, the serving radio network node of the UE is generally different from the radio network node which the UE requests to release resources: the UE enters an idle state while using the ProSe service, moves to the coverage of a new radio network node, and decides to terminate or temporarily deactivate the ProSe resource provided by radio network nodes other than the serving radio network node; or the UE accesses a new service provided by another radio network node while in the connected state. Accordingly, the serving radio network node of the UE refers to the radio network node selected or re-selected by the UE in the idle state or the radio network node being accessed by the UE in the connected state. The UE may also provide the identity of the UE in the radio network node which is requested to release the resources, e.g., a C-RNTI, when providing the identity or the address of the radio network node which is requested to release the resources for the serving radio network node.

The UE may request the radio network node to release the radio resources by sending a radio resources release request directly or via an MME to the radio network node. Alternatively, the UE may first request the ProSe function to terminate the ProSe, and the ProSe function requests the rradio network node via the MME to release the radio resources.

The resources configured to the ProSe may be resources shared by UEs or a group of UEs. The UE may be a member of the group or a UE managing the group.

After receiving the ProSe radio resources release request from the first UE, the eNB may send a response to confirm the first UE to releases the radio resources configured for the ProSe service (e.g. direct discovery and communication service). UE may release radio resources configured for the ProSe service until it receives the response from the eNB.

2. After the UE moves to the coverage of another radio network node (denoted as second radio network node) and the second radio network node re-configures radio resources to the UE for the ProSe, the second radio network node instructs the radio network node to release the radio resources.

In an example, after the handover of the UE from a serving eNB to a target eNB is completed, the target eNB instructs the serving eNB directly or via the MME to release the radio resources.

In another example, when the UE moves to the coverage of another radio network node, denoted as second radio network node, (as in the scenario of the above manner 1) and requests the second radio network node to configure resources, the UE may provide the identity or the address of the radio network node which is requested to release the resources. The second radio network node may send a resources release request to the radio network node and provide the identity of the UE or the identity of the resources or the identity of the ProSe. The UE may also provide the identity of the UE in the radio network node which is requested to release the resources, e.g., a C-RNTI, when providing the serving radio network node with the identity or the address of the radio network node which is requested to release the resources.

3. The network configures in the UE a periodicity of a ProSe state report or pages the UE to avoid releasing UE context when the UE has no data exchange with the network while using the ProSe. If a state report is not received from the UE within a pre-set time period or a paging response is not received after a pre-set number of times of paging, the radio network node decides to release the resources configured to the UE and delete the UE context.

4. The MME requests the radio network node to release the radio resources configured to the UE for the ProSe. The ProSe may be a ProSe direct discovery service or a ProSe direct communication service.

5. The ProSe function requests the radio network node to release the radio resources configured to the UE for the ProSe. After terminating the ProSe of the UE, the ProSe function requests the radio network node to release the radio resources configured to the UE directly or via the MME. The ProSe may be a ProSe direct discovery service or a ProSe direct communication service.

At block 202, the radio network node releases the radio resources configured to the UE for the ProSe sevice. The ProSe service may be a ProSe direct discovery service or a ProSe direct communication service.

For a UE to which radio resources required by a ProSe have been configured, the network may maintain a UE context identifiable by the identity of the UE to specify the radio resources configured to the UE for the ProSe. The identity of the UE may be a GUTI, an IMSI, an S-TMSI, or a C-RNTI. For a UE group to which radio resources required by a ProSe have been configured, the network may maintain a UE group context identifiable by the identity of the UE group to specify the radio resources configured to the UE group for the ProSe and members of the UE group within a cell or the coverage of the radio network node.

In an example, after receiving a resources release request or a context release request sent by a member of the UE group, the radio network node may delete the UE context of the member while preserving the resources configured to the UE group for the ProSe. When a resources release request or a context release request sent by the last member of the UE group is received, the radio network node releases the radio resources configured to the UE group for the ProSe.

When a UE enters the RRC idle state while using a ProSe, the radio network node does not delete UE context for the ProSe until being requested to release the radio resources configured to the UE by the UE or another radio network node or an MME or a ProSe function.

Alternatively, the UE is kept in the RRC connected state while using the ProSe until the radio network node fails to receive a ProSe state report from the UE within a preset time period or fails to receive a paging response from the UE after a pre-set number of times of paging.

The radio resources are radio time/frequency resources, may be an index of time/frequency resources or a sub frame or a PRB.

At block 203, the radio network node updates monitor configurations in UEs that are monitoring signals in the same cell with the UE that transmits signals.

In this procedure, if a second UE that monitors signals no longer needs to monitor the radio resources of the first UE or the UE group that transmits signals, e.g., when the resources are no longer for the ProSe, the radio network node updates monitor configurations of UEs that monitor signals and are within the same cell with the first UE, and re-specifies information of to-be-monitored resources. If the released radio resources are configured for another ProSe and the second UE is still required to monitor the radio resources, the monitor configurations of the second UE may not be updated, thus the procedure in block 203 may be omitted. Thus, the block 203 is optional. The second UE is a UE that monitors information transmitted by a UE that transmits signals in a ProSe direct discovery service or in a ProSe direct communication service.

In an example, the second UE may also monitor signals transmitted by a UE in an adjacent cell. If the second UE no longer needs to monitor the radio resources of the first UE or the UE group, the radio network node may inform radio network nodes of adjacent cells of the change in the state of the resources to let the radio network nodes of the adjacent cells to decide whether to update monitor configurations of UEs that monitor signals.

The procedure of the radio network node updates monitor configurations of UEs in the same cell with the UE that transmits signals and UEs in adjacent cells may include:

if the radio resources to be monitored is sent to the UEs that monitors signals via ProSe system broadcast messages, the radio network node does not broadcast the radio resources in the broadcast messages or specifies that the radio resources have been deleted.

When the radio resources to be monitored is sent to the UEs that monitor signals via UE-specific RRC signaling, the radio network node may instruct the UEs not to monitor the radio resources or that the radio resources have been deleted via the RRC signaling. The radio resources may include radio network resources of the local cell and radio network resources of adjacent cells.

In the above description, if the release of the radio resources is resulted from the UE moving to the coverage of another radio network node, the cell where the UE belongs refers to the cell where the UE belonged before the UE moves.

The process of the method for resources maintenance and release is terminated.

As described above, there are five manners for triggering the process of releasing radio resources, and the five manners are described in detail below.

### Example 1

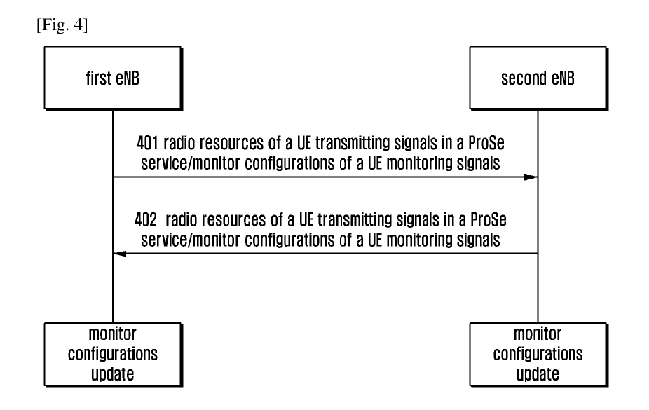

In an example, a UE requests a radio network node to release radio resources. The radio network node is an eNB serving the UE. FIG. 3 is a flowchart illustrating a method for maintenance and release of UE resources in accordance with an example of the present disclosure. The method may include the following procedures.

At block 301, a ProSe service is established, and the network configures radio resources required for ProSe service by an authorized firstUE that transmits signals.

In subsequent procedures, when deciding to terminate the ProSe service or to release the radio resource configured for ProSe service of first UE, the first UE may request the network to release the resources configured for ProSe service using any of but not limited to the three methods as described in blocks 302-305, blocks 306-310 and blocks 311-316. The procedure in block 317 is performed after any of the three methods is completed.

At block 302, the first UE sends a ProSe radio resources release request(request to release the radio resources configured for ProSe) to the eNB. It may specify the identity of the first UE or the identity of the ProSe service or the identity of the radio resources.

If the radio resources are shared by a group of UEs that transmit signals, the first UE may also specify the identity of the UE group when requesting the eNB to release the radio resources.

If the first UE is in the RRC connected state, the first UE may sends an RRC reconfiguration request to the eNB to request to release the radio resources configured for the ProSe service of the first UE.

If the first UE is in an RRC reestablishment state, e.g., the radio link is failed or the like, the first UE may request the eNB to request to release the radio resources configured for the ProSe service after the RRC connection is reestablished, or specify the radio resources is to be released in an RRC establishment reason in an RRC reestablishment request sent to the eNB.

If the first UE is in an RRC idle state, the first UE may request the eNB to release the radio resources configured for the ProSe service after an RRC connection is established, or specify the radio resources is to be released in an RRC establishment reason in an RRC establishment request sent to the eNB.

At block 303, the eNB may release the radio resources configured for the ProSe of the UE according to the request of the first UE.

If the first UE is in the RRC connected state, the eNB may release the radio resources for ProSe direct discovery/ProSe direct communication service of the first UE and perform RRC reconfiguration for the first UE.

If the first UE is in the RRC connected state and there is no other active radio bearers between the network and the first UE, the eNB may release the resources configured for the ProSe and release the RRC connection with the first UE.

If the first UE requests release of the radio resources for the ProSe service via an RRC reestablishment request, the eNB may release the resources for a discovery service of the first UE and return an RRC reestablishment rejection to the first UE, and the reason for the rejection may be release of ProSe resources.

If the first UE requests release of the radio resources for the ProSe service via an RRC connection request, the eNB may return an RRC establishment rejection to the first UE, and the reason for the rejection is release of the ProSe resources. The eNB may alternatively not return the RRC establishment rejection to the first UE.

After receiving the ProSe radio resources release request from the first UE, the eNB may send a response to confirm the first UE to releases the radio resources configured for the ProSe service (e.g. direct discovery and communication service). The above response from eNB may be carried on the existing/new RRC message, e.g., RRC Reconfiguration Request message. UE may release radio resources configured for the ProSe service until it receives the response from the eNB.

At block 304, the eNB may send a resources release notificatonion to an MME indicating the radio resources of the ProSe service of the first UE has been released. The eNB may also specify the reason for the resources release. The MME may decide whether to release ProSe context of the first UE or perform resources re-allocation according to the reason for the resources release.

At block 305, the MME may forward the resources release notification to the ProSe function. The MME may also specify the reason for the resources release. The ProSe function may decide whether to release ProSe context of the first UE or perform resources re-allocation according to the reason for the resources release. The MME may also provide the ProSe function with the identity of the eNB.

Hence, the first manner (i.e., the first UE directly requests the eNB to release resources) of requesting resources release and the network releasing the radio resources is completed, and the procedure in block 317 is performed. The following is the second manner (the first UE requests the eNB via an MME to release the resources) of requesting resources release and the network releasing the radio resources.

At block 306, the first UE sends a ProSe radio resources release request to an MME, and specifies the identity of the first UE or the identity of the ProSe service or the identity of the radio resources.

If the radio resources are shared by a group of UEs that transmit signals, the first UE may also specify the identity of the UE group when requesting the MME to release the radio resources.

The first UE may also specify the identity of the radio resources or the identity of the eNB to which the radio resources belong.

If the above fourth method of triggering the release of radio resources (i.e., the MME triggers the release of radio resources) is adopted, the procedures in blocks 307-310 may be directly performed after the procedure of block 301. The process of the fourth method of triggering the release is not repeated herein.

At block 307, the MME sends a resources release request or a UE context release request to the eNB. The eNB may be the eNB that is serving the first UE, or the eNB specified by the first UE.

At block 308, the eNB releases the radio resources of the ProSe service according to the request of the MME, and performs RRC reconfiguration or RRC release for the first UE.

At block 309, the eNB sends a resources release response to the MME indicating that the resources have been released. This procedure is optional.

At block 310, the MME sends a resources release notification to the ProSe function. The MME may also specify the reason for the resources release. The ProSe function may decide whether to release ProSe context of the first UE or perform resources reallocation according to the reason for the resources release. The MME may also provide the ProSe function with the identity of the eNB.

Hence, the second manner (i.e., the first UE requests the eNB via the MME to release resources) of requesting resources release and the network releasing the radio resources is completed, and the procedure in block 317 is performed. The following is the third manner (the first UE requests the eNB via an MME and a ProSe function to release the resources) of requesting resources release and the network releasing the radio resources.

At block 311, the first UE sends a ProSe radio resources release request or a ProSe termination request to a ProSe function, and specifies the identity of the first UE or the identity of the ProSe service or the identity of the radio resources.

If the radio resources are shared by a group of UEs that transmit signals, the first UE may also specify the identity of the UE group when requesting the ProSe function to release the radio resources.

The first UE may also specify the identity of the radio resources of the ProSe service or the identity of the eNB to which the radio resources belong.

The first UE may also specify the identity of the MME to which the ProSe service belongs.

If the above fifth method of triggering the release of radio resources (i.e., the ProSe function triggers the release of radio resources) is adopted, the procedures in blocks 312-316 may be directly performed after the procedure of block 301. The process of the fifth method of triggering the release is not be repeated herein.

At block 312, the ProSe function sends a resources release request or a UE context release request to an MME. The MME may be the MME that is serving the first UE, or the MME specified by the first UE.

The ProSe function may also specify the identity of the radio resources of the ProSe of the first UE or the identity of the eNB to which the radio resources belong.

At block 313, the MME sends a resources release request to the eNB. The eNB may be the eNB that is serving the first UE, or the eNB specified by the ProSe function.

At block 314, the eNB releases the radio resources of the ProSe service according to the request of the MME, and performs RRC reconfiguration or RRC release for the first UE.

At block 315, the eNB sends a resources release response to the MME indicating that the resources have been released. This procedure is optional.

At block 316, the MME sends a resources release response to the ProSe function indicating that the resources have been released.

Hence, the second manner (i.e., the first UE requests the eNB via the MME to release resources) of requesting resources release and the network releasing the radio resources is completed, and the procedure in block 317 is performed.

At block 317, the eNB may update monitor configurations of UEs that are monitoring signals and are within the coverage of the eNB so that the UEs may choose not to monitor the released radio resources of the ProSe services.

The eNB may also inform adjacent eNBs to update monitor configurations of UEs within respective coverage.

After this procedure, the method for maintenance and release of UE resources of example one is completed. Regarding block 317 in which the eNB may inform neighboring eNBs of the change in resources state, the neighboring eNBs may decide whether to update monitor configurations of UEs within respective coverage. A neighboring eNB may store radio resources configured by the eNB to UEs that transmit signals and monitor configurations, and configure UEs within the coverage of the neighboring eNB accordingly to facilitate the update of monitor configurations of neighboring eNBs. The process is described below in example two.

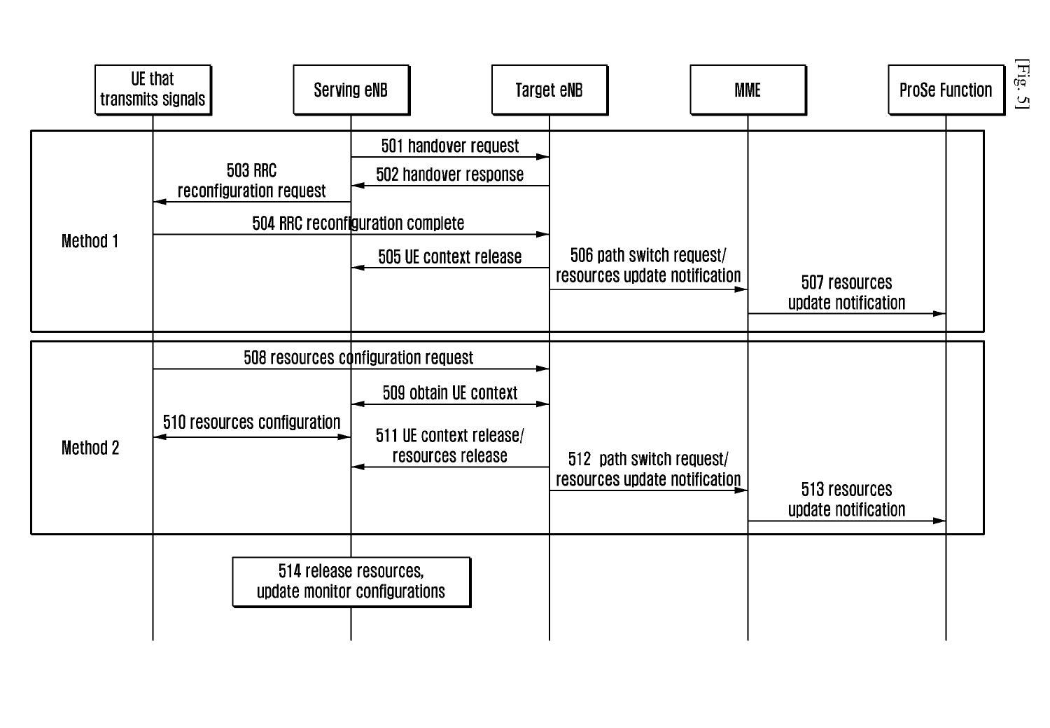

FIG. 4 is a flowchart illustrating a method for maintenance and release of UE resources in accordance with example two of the present disclosure. The method may include the following procedures.

At block 401, a first eNB and a second eNB are neighbors. The first eNB sends radio resources configured to a UE that transmits signals and is within the coverage of the first eNB or monitor configurations of a UE that monitors signals and is within the coverage of the first eNB to the second eNB. The second eNB configures neighbor monitor configurations in UEs that monitor signals in a ProSe service and are within the coverage of the second eNB according to the radio resources or monitor configuration provided by the first eNB. Thus, UEs that monitor signals and are located in cell edge or eNB edge areas are enabled to monitor information transmitted by UEs that transmit signals and are within an adjacent cell or within the coverage of a neighboring eNB.

The radio resources of a ProSe service of a UE that transmits signals or the monitor configurations of a UE that monitors signals may be sent to the second eNB via an X2 interface establishment request or an eNB configuration update request or a resources state request, and specifies radio resources planned or configured in real time for the ProSe service in the coverage or the cell of the first eNB, e.g., may specify an index of a frequency or a bandwidth.

At block 402, the second eNB sends radio resources configured to a UE that transmits signals and is within the coverage of the second eNB or monitor configurations of a UE that monitors signals and is within the coverage of the second eNB to the first eNB. The first eNB configures neighbor monitor configurations in UEs that monitor signals in a ProSe service and are within the coverage of the first eNB according to the radio resources or monitor configuration provided by the second eNB. Thus, UEs that monitor signals and are located in cell edge or eNB edge areas are enabled to monitor information transmitted by UEs that transmit signals and are within an adjacent cell or within the coverage of a neighboring eNB.

The radio resources of a ProSe service of a UE that transmits signals or the monitor configurations of a UE that monitors signals may be sent to the first eNB via an X2 interface establishment response or an eNB configuration update or a resources state response, and specifies radio resources planned or configured in real time for the ProSe service in the coverage or the cell of the second eNB, e.g., may specify an index of a frequency or a bandwidth.

After this procedure, the method for maintenance and release of UE resources of example two is completed.

According to above second method for triggering the release of radio resources, a UE performs cell switch after moving into the coverage of the adjacent radio network node, and the process of the serving cell releasing the radio resources of the ProSe service of the UE is triggered. The handover of the UE from a serving eNB to a target eNB may be carried out in two manners, i.e., via an X2 interface or via an S1 interface. Accordingly, there are also two manner of triggering the serving eNB to release the radio resources, i.e., via an X2 interface or via an S2 interface. The processes of maintenance and release of UE resources respectively via an X2 interface and via an S1 interface in case of a handover are described in the following example three and example four.

### Example 3

In this example, a UE is handed over from a source serving eNB to a target eNB via an X2 interface, and the target eNB triggers the serving eNB to release radio resources. FIG. 5 is a schematic diagram illustrating a method for maintenance and release of UE resources in accordance with example three of the present disclosure. This example describes the process of releasing radio resources of a UE that transmits signals for a ProSe via an X2 interface.

When a UE that transmits signals moves into the coverage of a neighboring eNB while using a ProSe service, two manners may be adopted to implement resources update, i.e., by triggering a handover process by the serving eNB or by the UE as described in blocks 501-507 and blocks 508-513 respectively. The procedure in block 514 is directly performed after the procedures of any of the above manners are completed.

At block 501, a UE that transmits signals is in an RRC connected state. A serving eNB decides to hand the UE over to a target eNB according to a measurement report. The serving eNB sends a handover request to the target eNB, and may specify the radio resources configuration required by the UE for ProSe service.

If the radio resources are configured for a group of UEs that transmit signals, the serving eNB may specify the identity of the UE group when sending the handover request to the target eNB.

At block 502, the target eNB prepares the radio resources required by the ProSe service for the UE according to the handover request, and returns a handover response to the serving eNB.

At block 503, the serving eNB performs RRC reconfiguration to the UE to configure radio resources required by the ProSe of the UE to be the radio resources reserved by the target eNB, and the UE is handed over to the target eNB.

At block 504, the UE sends an RRC reconfiguration complete message to the target eNB indicating the handover is completed.

At block 505, the target eNB sends a UE context release request or resources release request to the serving eNB instructing the serving eNB to release context related with the UE or the radio resources configured to the UE.

If transmission resources are shared by a group of UEs that transmit signals, the serving eNB releases the transmission resources shared by the group only when all of the UEs in the group have been released or handed over.

At block 506, the target eNB sends a path switch request or a resources update notification to an MME, may indicating the eNB of the ProSe service of the UE is the target eNB.

At block 507, the MME may send a resources update notification to a ProSe function after confirming the reception of the path switch request or the resources update notification.

At this procedure, the process of releasing radio resources triggered by a handover initiated by the serving eNB is completed, and the procedure in block 514 is performed to update monitor configurations.

At block 508, the UE processes measurement for signals from the target cell. When the target cell is more suitable for accessing or the current serving cell cannot meet the service requirement, the UE sends a resources allocation request to a target eNB and it may specifies the identity or the address of the serving eNB or the identity of the serving cell.

At block 509, the target eNB identifies the serving eNB according to the identity or the address of the serving eNB or the identity of the serving cell, obtains context of the UE from the serving eNB, and checks whether radio resources required by the proximity service of the UE can be configured.

At block 510, the target eNB configures radio resources required by the ProSe service for the UE.

At block 511, the target eNB sends a UE context release request to the serving eNB instructing the serving eNB to release context related with the UE or the radio resources configured to the UE.

If transmission resources are shared by a group of UEs that transmit signals, the serving eNB releases the transmission resources shared by the group only when all of the UEs in the group have been released or handed over.

At block 512, the target eNB may send a path switch request or a resources update notification to an MME indicating the eNB of the ProSe service of the UE is the target eNB.

At block 513, the MME sends a resources update notification to a ProSe function after confirming the reception of the path switch request or the resources update notification.

At this procedure, the process of releasing radio resources triggered by a handover initiated by the UE is completed, and the procedure in block 514 is performed to update monitor configurations.

At block 514, the eNB may update monitor configurations of UEs that are monitoring signals and are within the coverage of the eNB so that the UEs may choose not to monitor the released radio resources of the ProSe services.

The eNB may also inform adjacent eNBs to update monitor configurations of UEs within respective coverage.

After this procedure, the method for maintenance and release of UE resources of example three is completed.

### Example 4

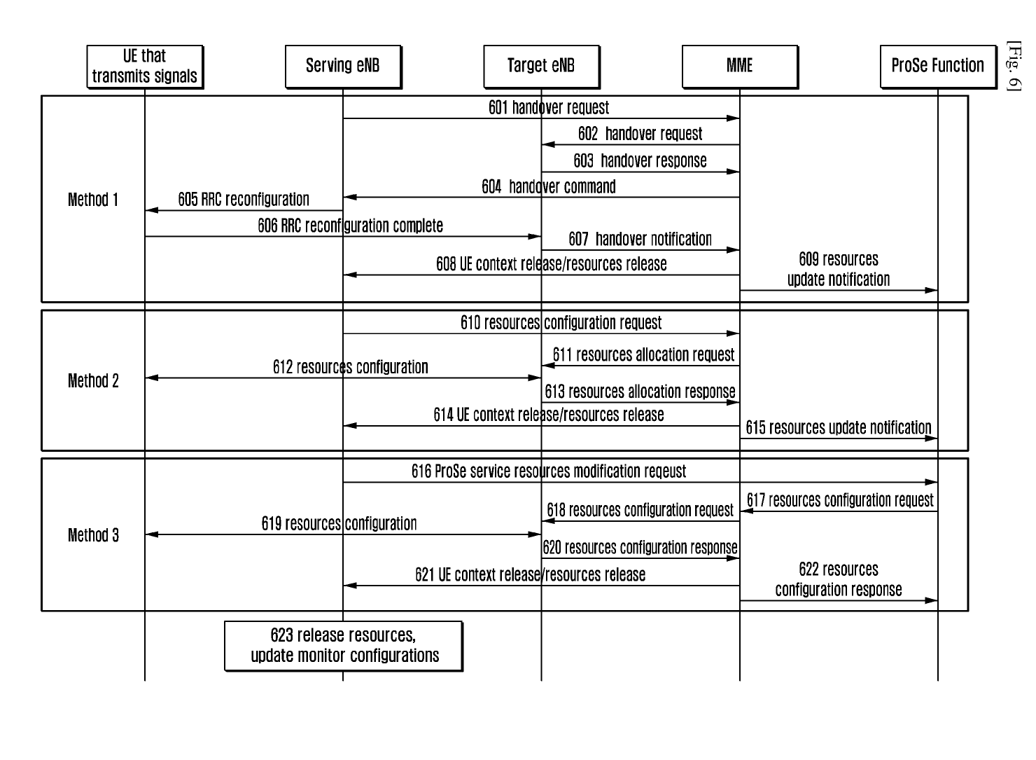

FIG. 6 is a schematic diagram illustrating a method for maintenance and release of UE resources in accordance with example four of the present disclosure. This example describes the process of releasing radio resources of a UE that transmits signals for a ProSe service via an S1 interface.

When a UE that transmits signals moves into the coverage of a neighboring eNB while using a ProSe service, three manners may be adopted to implement resources update, i.e., as described in blocks 601-609, blocks 610-615, and blocks 616-622 respectively. The procedure in block 623 is directly performed after the procedures of any of the above manners are completed.

At block 601, a UE that transmits signals is in an RRC connected state. A serving eNB decides to hand the UE over to a target cell according to a measurement report. The serving eNB sends a handover request to an MME. The serving eNB may specify radio resources required by the ProSe service of the UE.

If the radio resources are shared by a group of UEs that transmit signals, the serving eNB may also specify the identity of the UE group when sending the handover request to the MME.

At block 602, the MME sends a handover request to the target eNB, and may specify the radio resources required by the ProSe service of the UE.

If the radio resources are shared by a group of UEs that transmit signals, the MME may specify the identity of the UE group when sending the handover request to the target eNB.

At block 603, the target eNB reserves the radio resources required by the ProSe service for the UE according to the handover request, and returns a handover response to the MME.

At block 604, the MME sends a handover command to the serving eNB instructing the serving eNB to configure radio resources required by the ProSe service of the UE to be the radio resources reserved by the target eNB and to hand the UE over to the target eNB.

At block 605, the serving eNB configures radio resources required by the ProSe service of the UE to be the radio resources reserved by the target eNB, and the UE is handed over to the target eNB.

At block 606, the UE returns an RRC reconfiguration complete message to the target eNB indicating the handover is completed.

At block 607, the target eNB sends a handover notification to the MME indicating the handover is completed. The handover notification may specify updated resources configurations.

At block 608, the MME sends a UE context release request or resources release request to the serving eNB instructing the serving eNB to release context related with the UE or the radio resources configured to the UE.

If transmission resources are shared by a group of UEs that transmit signals, the serving eNB releases the transmission resources shared by the group only when all of the UEs in the group have been released or handed over.

At block 609, the MME sends a resources update notification to a ProSe function after receiving the handover notification from the target eNB.

After this procedure, the first manner of updating resources is completed, and the procedure in block 623 is performed.

At block 610, the UE searches for signals of the target cell, and sends a resources allocation request to the MME when determining the target cell is more suitable for accessing or the current serving cell cannot meet the service requirements. The UE may at the same time specify the identity or the address of the serving eNB or the identity of the serving cell.

At block 611, the MME may directly identifies the serving eNB or by using the identity or the address of the serving eNB or the identity of the serving cell, obtains context of the UE from the serving eNB, and checks whether radio resources required by the ProSe service of the UE can be configured. Alternatively, the MME may directly checks whether radio resources required by the ProSe service of the UE can be configured at the target eNB.

The MME sends a resources configuration request to the target eNB.

At block 612, the target eNB configures radio resources required by the ProSe service for the UE.

At block 613, the target eNB returns a resources configuration response to the MME.

At block 614, the MME sends a UE context release request or resources release request to the serving eNB instructing the serving eNB to release context related with the UE or the radio resources configured to the UE.

If transmission resources are shared by a group of UEs that transmit signals, the serving eNB releases the transmission resources shared by the group only when all of the UEs in the group have been released or handed over.

At block 615, the MME sends a resources update notification to a ProSe function after receiving a resources allocation complete notification from the target eNB. The MME may specify that the eNB of the ProSe service of the UE has switched to be the target eNB.

After this procedure, the second manner of updating resources is completed, and the procedure in block 623 is performed.

At block 616, the UE searches for signals of the target cell and sends a resources update request to a ProSe function when determining the target cell is more suitable for accessing or the current serving cell cannot meet the service requirements. The UE may at the same time specify the identity or the address of the serving eNB or the identity or the address of the serving MME. The UE may at the same time specify the identity of the target eNB, the address of the serving/target eNB, the identity of the target cell, or the identity or the address of the target MME.

At block 617, the ProSe function may identify the serving MME of the UE directly or by using the identity or the address of the serving eNB or the identity or the address of the serving MME or the identity or the address of the target MME, sends a resources update request to the MME and specifies the target eNB. The ProSe function may at the same time specify the identity or the address of the serving eNB or the identity of the serving cell.

At block 618, the MME may directly identifies the serving eNB or by using the identity or the address of the serving eNB or the identity of the serving cell, obtains context of the UE from the serving eNB, and checks whether radio resources required by the ProSe service of the UE can be configured. Alternatively, the MME may directly checks whether radio resources required by the ProSe service of the UE can be configured at the target eNB.

The MME confirms the target eNB according to an instruction of the ProSe function, and sends a resources configuration request to the target eNB.

At block 619, the target eNB configures radio resources required by the ProSe service for the UE.

At block 620, the target eNB returns a resources configuration response to the MME.

At block 621, the MME sends a UE context release request or resources release request to the serving eNB instructing the serving eNB to release context related with the UE or the radio resources configured to the UE.

If transmission resources are shared by a group of UEs that transmit signals, the serving eNB releases the transmission resources shared by the group only when all of the UEs in the group have been released or handed over.

At block 622, the MME sends a resources update notification to a ProSe function after receiving a resources allocation completed notification from the target eNB. The MME may specify that the eNB of the ProSe service of the UE has switched to be the target eNB.

After this procedure, the third manner of updating resources is completed, and the procedure in block 623 is performed.

At block 623, the eNB may update monitor configurations of UEs that are monitoring signals and are within the coverage of the eNB so that the UEs may choose not to monitor the released radio resources of the ProSe services.

The eNB may also inform adjacent eNBs to update monitor configurations of UEs within respective coverage.

After this procedure, the method for maintenance and release of UE resources of example four is completed.

According to the above third manner of triggering the release of radio resources, an eNB initiates the release of radio resources when a UE does not feed back a periodic state report or a paging response within a pre-set time period. The method is described in further detail in the following example five and example six.

### Example 5

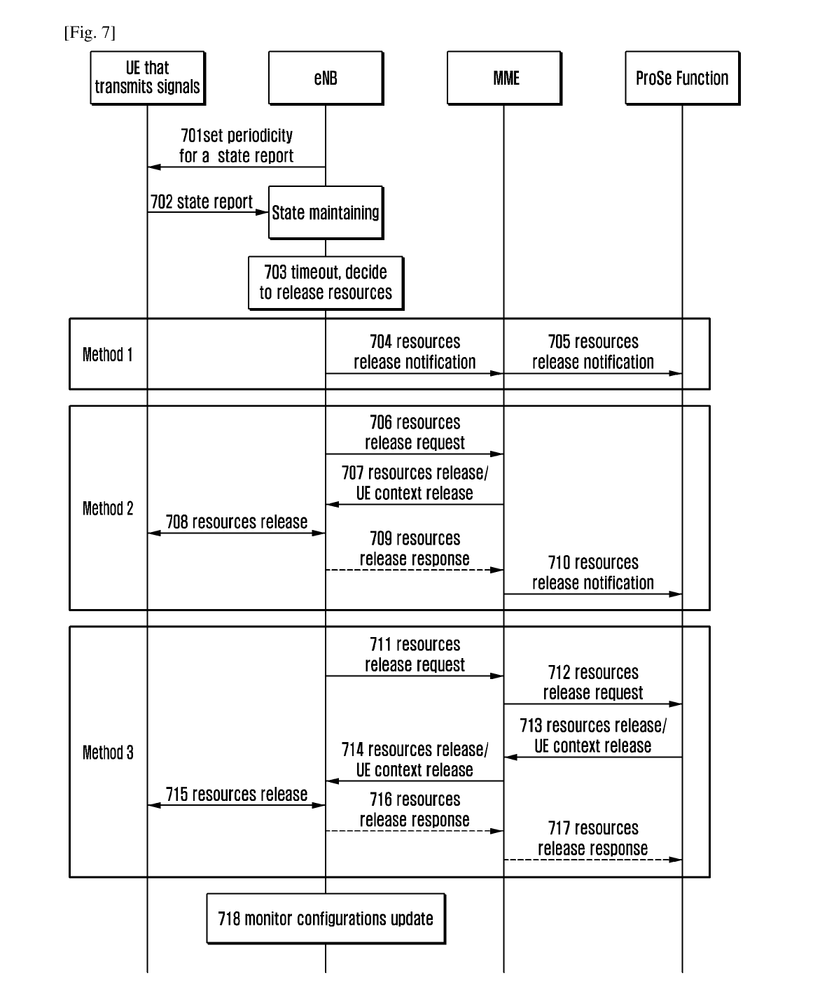

FIG. 7 is a schematic diagram illustrating a method for maintenance and release of UE resources in accordance with example five of the present disclosure. This example describes maintaining a state. After a network configured radio resources to a UE for a ProSe, the network may keep the UE at a connected state. The state may be maintained by using state reports to avoid release of an RRC connected resulted from no data exchange between the UE and the network.

At block 701, an eNB may configure a periodicity of state reports in a UE either directly or when any of the two following situations occurs: 1) allocating resources required by a discovery service to the UE, 2) deciding to release the context of the UE due to no data exchange between the UE and the network.

The periodicity may be a periodicity for feeding back an individual state report or a measurement report or an accounting report or RRC signaling or a NAS packet or a TAU or a data packet.

At block 702, the UE periodically returns a specified state report or a measurement report or an accounting report or RRC signaling or a NAS packet or a TAU or a data packet according to the configured periodicity. The eNB keeps the UE at the RRC connected state after receiving the information sent by the UE.

At block 703, if the state report is not received from the UE after a pre-set time period, e.g., the UE is powered off or has moved out of the coverage of the network, or if the ProSe of the UE specified in the state report has been terminated, the eNB may decide to release the radio resources configured to the ProSe of the UE. The length of the timeout period may be configured by a network administrator or by a ProSe function. There are three methods for releasing the radio resources, as described in blocks 704, 706 and 711 respectively.

At block 704, the eNB directly releases the radio resources configured to the ProSe of the UE, and sends a resources release notification to the MME after the release indicating the radio resources for the ProSe of the UE has been released. The eNB may also specify the reason for the resources release. The MME may decide whether to release ProSe context of the first UE or perform resources re-allocation according to the reason for the resources release.

If transmission resources are shared by a group of UEs that transmit signals, the serving eNB releases the transmission resources shared by the group only when all of the UEs in the group have been released or handed over.

At block 705, the MME forwards the resources release notification to the ProSe function. The MME may also specify the reason for the resources release. The ProSe function may decide whether to release ProSe context of the first UE or perform resources re-allocation according to the reason for the resources release. The MME may also provide the ProSe function with the identity of the eNB.

At block 706, the eNB sends a ProSe radio resources release request to an MME, and specifies the identity of the first UE or the identity of the ProSe or the identity of the radio resources.

If the radio resources are shared by a group of UEs that transmit signals, the eNB may also specify the identity of the UE group when requesting the MME to release the radio resources.

At block 707, the MME sends a resources release request or a UE context release request to the eNB.

At block 708, the eNB releases the radio resources of the ProSe according to the request of the MME, and performs RRC reconfiguration or RRC release for the first UE.

At block 709, the eNB sends a resources release response to the MME indicating that the resources have been released. This procedure is optional.

At block 710, the MME forwards the resources release notification to the ProSe function. The MME may also specify the reason for the resources release. The ProSe function may decide whether to release ProSe context of the first UE or perform resources re-allocation according to the reason for the resources release. The MME may also provide the ProSe function with the identity of the eNB.

At block 711, the eNB sends a ProSe radio resources release request to an MME, and specifies the identity of the first UE or the identity of the ProSe or the identity of the radio resources.

If the radio resources are shared by a group of UEs that transmit signals, the eNB may also specify the identity of the UE group when requesting the MME to release the radio resources.

At block 712, the MME sends a ProSe radio resources release request or a ProSe termination request to a ProSe function, and specifies the identity of the UE or the identity of the ProSe or the identity of the radio resources.

If the radio resources are shared by a group of UEs that transmit signals, the MME may also specify the identity of the UE group when requesting the ProSe function to release the radio resources.

The MME may also specify the identity of the radio resources of the ProSe or the identity of the eNB to which the radio resources belong.

At block 713, the ProSe function sends a resources release request or a UE context release request to an MME.

At block 714, the MME sends a resources release request to the eNB.

At block 715, the eNB releases the radio resources of the ProSe according to the request of the MME, and performs RRC reconfiguration or RRC release for the first UE.

At block 716, the eNB sends a resources release response to the MME indicating that the resources have been released. This procedure is optional.

At block 717, the MME sends a resources release response to the ProSe function indicating that the resources have been released. This procedure is optional.

At block 718, the eNB may update monitor configurations of UEs that are monitoring signals and are within the coverage of the eNB so that the UEs may choose not to monitor the released radio resources of the ProSes.

The eNB may also inform adjacent eNBs to update monitor configurations of UEs within respective coverage.

After this procedure, the method for maintenance and release of UE resources of example five is completed.

### Example 6

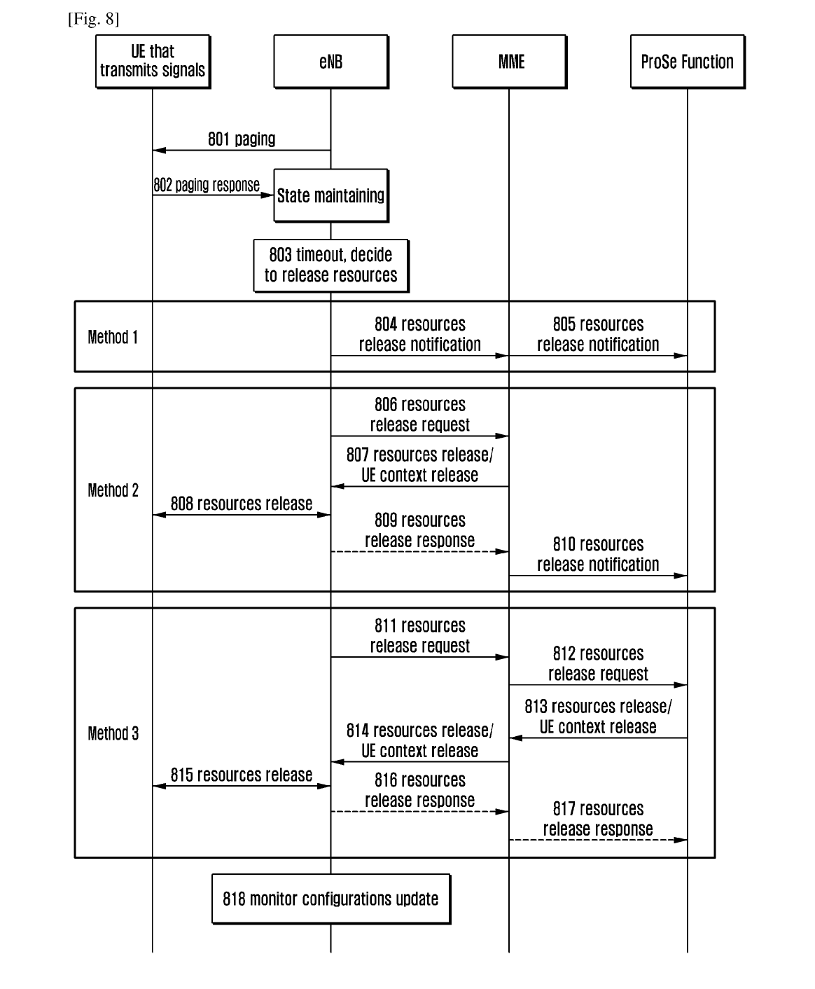

FIG. 8 is a schematic diagram illustrating a method for maintenance and release of UE resources in accordance with example six of the present disclosure. This example describes maintaining a state. After a network configured radio resources to a UE for a ProSe, the network may keep the UE at a connected state. The state may be maintained by using paging and paging responses to avoid release of an RRC connected resulted from no data exchange between the UE and the network.

At block 801, an eNB may perform state maintaining by paging a UE before deciding to release the context of the UE due to no data exchange between the UE and the network. If a paging response is received, the UE is kept at a connected state. If a paging response is not received after a pre-set time period or after a pre-set maximum number of re-transmission of the paging, the context of the UE and resources are released. The eNB may send paging to the UE.

At block 802, the UE returns a paging response according to requirements of the paging.

At block 803, if the paging response is not received from the UE after a pre-set time period or after a pre-set maximum number of re-transmission of the paging, e.g., the UE is powered off or has moved out of the coverage of the network, or if the paging response indicates the ProSe of the UE has been terminated, the eNB may decide to release the radio resources configured to the ProSe of the UE. The length of the timeout period may be configured by a network administrator or by a ProSe function. There are three methods for releasing the radio resources, as described in blocks 804, 806 and 811 respectively.

Procedures in blocks 804 to 818 are the same with those in blocks 704 to 718, and will not be described further.

After this procedure, the method for maintenance and release of UE resources of example six is completed.

### Example 7

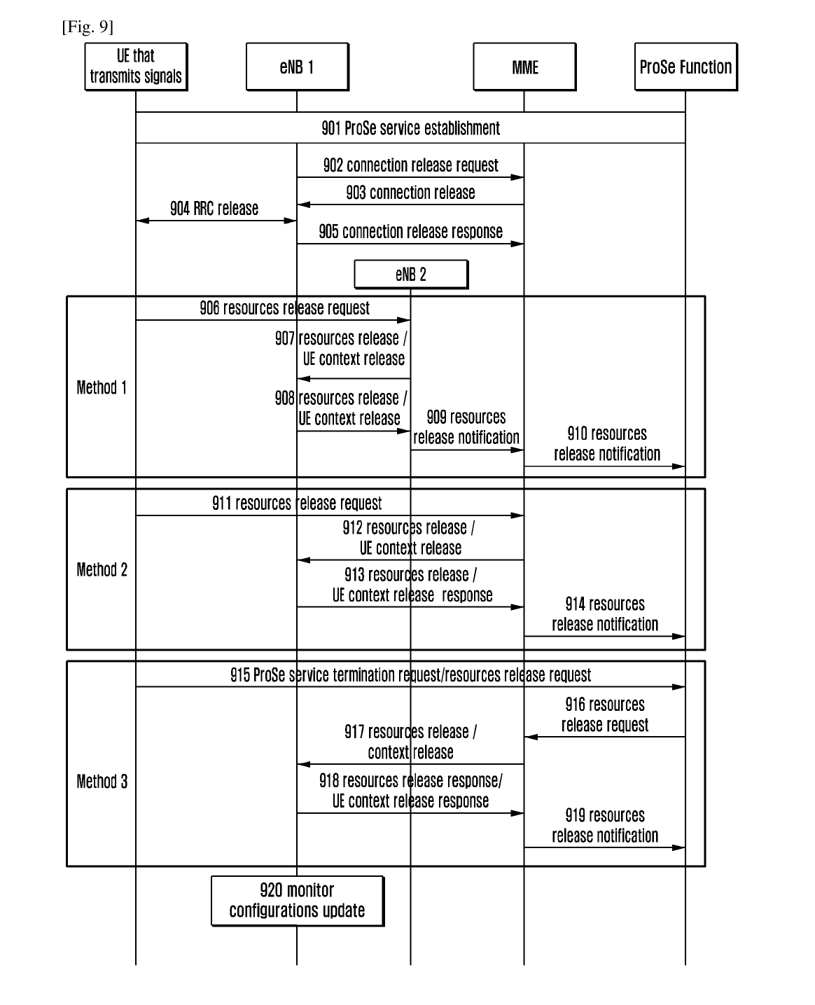

In this example, a UE requests a radio network node to release radio resources. The radio network node is not the serving radio network node of the UE. FIG. 9 is a schematic diagram illustrating a method for maintenance and release of UE resources in accordance with example seven of the present disclosure. An application scenario of this example is: a UE enters an idle state while using a ProSe after obtaining resources required by the ProSe, after that the UE moves into the coverage of a second radio network node and decides to terminate the ProSe or de-activate the resources; or the UE accesses another service of another radio network node while in the connected state, and the UE decides to terminate the ProSe or de-activate the resources, and then, the UE requests the network to release the resources. The following takes the scenario where the UE moves to the coverage of a second radio network node after entering the idle state as an example. As shown in FIG. 9, the method may include the following procedures.

At block 901, a ProSe is established, and the network configures radio resources required by the ProSe of an authorized first UE that transmits signals.

At block 902, after a UE is de-activated or after a time period of no exchange between the UE and the network, eNB 1 requests an MME to release an RRC connection of the UE when the UE subscribes to no other services of the network, specifying the reason for the release is that there is no interaction between the UE and the network.

At block 903, the MME instructs the eNB 1 to release the connection and to maintain ProSe context of the UE (i.e., the relationship between the UE and the resources configured for the ProSe) and the resources configured to the ProSe of the UE.

At block 904, the eNB 1 releases the RRC connection of the UE while maintaining the ProSe context of the UE and the resources configured to the UE for the ProSe.

At block 905, the UE may move into the coverage of another radio network node, e.g., eNB 2, while in the idle state and using the ProSe, and the UE may use three methods to request the network to release resources when decides to terminate the ProSe or release the radio resources. The three methods are described in blocks 906-910, blocks 911-914 and blocks 915-919 respectively. The procedure in block 920 is performed after the procedures of any of the three methods are performed.

At block 906, the UE that transmits signal sends a ProSe resources release request to the current serving eNB, i.e., eNB 2, specifying the identity or the address of eNB 1 that configured the resources for the ProSe of UE.

The UE may also specify the identity of the UE or the identity or the ProSe or the identity of the radio resources.

If the radio resources are shared by a group of UEs that transmit signals, the first UE may also specify the identity of the UE group when requesting the eNB to release the radio resources.

The first UE is in an RRC idle state, and may request the eNB to release the radio resources configured for the ProSe after an RRC connection is established, or specify the radio resources is to be released in an RRC establishment reason in an RRC establishment request sent to the eNB.

At block 907, the eNB releases resources of the ProSe according to the request of the first UE. The request may include the identity of the UE, the identity of a UE group, the identity of the ProSe, or the identity of the radio resources.

The identity of the UE may be a GUTI, an IMSI, an S-TMSI, or a C-RNTI. The eNB 2 may send the request to the eNB 1 via an S1 interface or an X2 interface.

At block 908, the eNB 1 releases the resources configured to the UE for the ProSe according to the request of the eNB 2, and deletes the ProSe context of the UE. The eNB 1 returns a resources release response or a UE context release response to the eNB 2.

For group-specific resources, after receiving a resources release request or a context release request sent by a member of the UE group, the radio network node may delete the UE context of the member while preserving the resources configured to the UE group for the ProSe. When a resources release request or a context release request sent by the last member of the UE group is received, the radio network node releases the radio resources configured to the UE group for the ProSe.

At block 909, the eNB 2 sends a resources release notification to an MME indicating the radio resources of the ProSe of the UE has been released. The eNB 2 may also specify the reason for the resources release. The MME may decide whether to release ProSe context of the first UE or perform resources re-allocation according to the reason for the resources release.

At block 910, the MME forwards the resources release notification to the ProSe function. The MME may also specify the reason for the resources release. The ProSe function may decide whether to release ProSe context of the first UE or perform resources re-allocation according to the reason for the resources release.

Hence, the first manner (i.e., the first UE directly requests the eNB to release resources) of requesting resources release and the network releasing the radio resources is completed, and the procedure in block 911 is performed. The following is the second manner (the UE requests the eNB via an MME to release the resources) of requesting resources release and the network releasing the radio resources.

At block 911, the UE sends a ProSe resources release request to the MME, specifying the identity or the address of the eNB 1 that configured the resources, and may further specify the identity of the UE, the identity of the ProSe, or the identity of the radio resources.

If the radio resources are shared by a group of UEs that transmit signals, the first UE may also specify the identity of the UE group when requesting the MME to release the radio resources.

The first UE may also specify the identity of the radio resources or the identity of the eNB to which the radio resources belong.

At block 911, the MME sends a resources release request or a UE context release request to the eNB 1 according to the request of the UE.

At block 912, the eNB 1 releases the resources of the ProSe according to the request of the MME, and deletes the ProSe context of the UE.

At block 913, the eNB 1 sends a resources release response or a UE context release response to the MME indicating that the resources have been released. This procedure is optional.

At block 914, the MME forwards the resources release notification to the ProSe function. The MME may also specify the reason for the resources release. The ProSe function may decide whether to release ProSe context of the first UE or perform resources re-allocation according to the reason for the resources release.

Hence, the second manner (i.e., the UE requests the eNB via the MME to release resources) of requesting resources release and the network releasing the radio resources is completed, and the procedure in block 915 is performed. The following is the third manner (the UE requests the eNB via an MME and a ProSe function to release the resources) of requesting resources release and the network releasing the radio resources.

At block 915, the UE sends a ProSe resources release request or a ProSe termination request to a ProSe function, specifying the identity or the address of the eNB 1 that configured the resources to the UE, and may further specify the identity of the UE, the identity of the ProSe, or the identity of the radio resources.

If the radio resources are shared by a group of UEs that transmit signals, the first UE may also specify the identity of the UE group when requesting the ProSe function to release the radio resources.

The first UE may also specify the identity of the radio resources of the ProSe or the identity of the eNB to which the radio resources belong.

The first UE may also specify the identity of the MME to which the ProSe belongs.

At block 916, the ProSe function sends a resources release request or a UE context release request to an MME. The MME may be the MME that is serving the first UE, or the MME specified by the first UE.

The ProSe function may also specify the identity of the radio resources of the ProSe of the first UE or the identity of the eNB to which the radio resources belong.

At block 917, the MME sends a resources release request to the eNB 1. The eNB may be the eNB that is serving the first UE, or the eNB specified by the ProSe function.

At block 918, the eNB 1 releases the resources of the ProSe according to the request of the MME, and deletes the ProSe context of the UE.

At block 919, the eNB 1 sends a resources release response or a UE context release response to the MME indicating that the resources have been released. This procedure is optional.

The MME sends a resources release response to the ProSe function indicating the resources have been released.

Hence, the third manner (i.e., the UE requests the eNB via the MME to release resources) of requesting resources release and the network releasing the radio resources is completed, and the procedure in block 920 is performed.

At block 920, the eNB may update monitor configurations of UEs that are monitoring signals and are within the coverage of the eNB so that the UEs may choose not to monitor the released radio resources of the ProSes.

The eNB may also inform adjacent eNBs to update monitor configurations of UEs within respective coverage.

After this procedure, the method for maintenance and release of UE resources of example seven is completed. In block 920 it is mentioned that the eNB may instruct neighboring eNBs to update monitor configurations of UEs in respective coverage. In order to implement update of monitor configurations across neighboring eNBs, neighboring eNBs may store radio resources configured by each other to respective UEs and monitor configurations of each other, and configure UEs that monitor signals and are within respective coverage. The process may be similar to that described in example two.

### Example 8

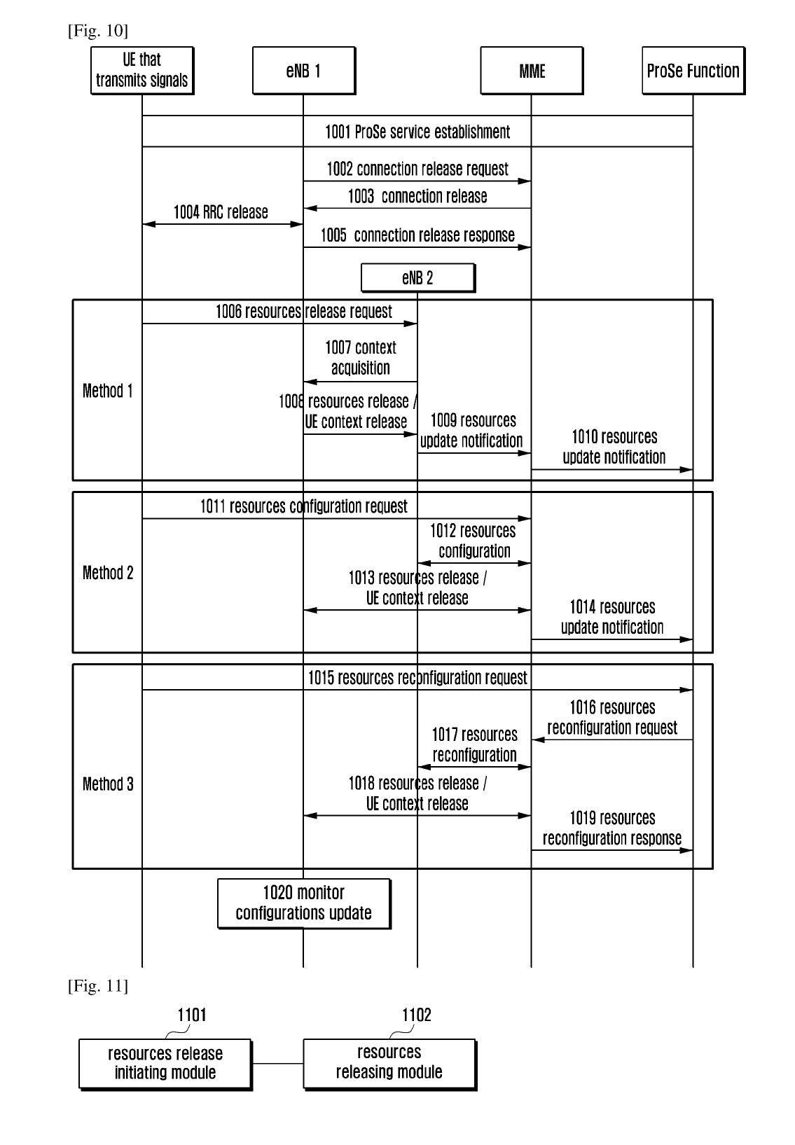

In this example, a UE requests a radio network node to reconfigure radio resources for the ProSe. The radio network node is not the serving radio network node of the UE. FIG. 10 is a schematic diagram illustrating a method for maintenance and release of UE resources in accordance with example eight of the present disclosure. The application scenario of this example is: after a radio network node configures radio resources to a UE, the UE enters an RRC idle state while using the ProSe, and then moves into the coverage of a second radio network node; the UE requests the second radio network node to reconfigure resources for the ProSe, and instructing the second radio node to request the serving radio network node to release the radio resources configured to the UE for the ProSe. As shown in FIG. 10, the method may include the following procedures.

At block 1001, a ProSe is established, and the network configures radio resources required by the ProSe of an authorized first UE that transmits signals.

At block 1002, after a UE is de-activated or after a time period of no exchange between the UE and the network, eNB 1 requests an MME to release an RRC connection of the UE when the UE subscribes to no other services of the network, specifying the reason for the release is that there is no interaction between the UE and the network.

At block 1003, the MME instructs the eNB 1 to release the connection and to maintain ProSe context of the UE (i.e., the relationship between the UE and the resources configured for the ProSe) and the resources configured to the ProSe of the UE.

At block 1004, the eNB 1 releases the RRC connection of the UE while maintaining the ProSe context of the UE and the resources configured to the UE for the ProSe.

At block 1005, the UE may move into the coverage of another radio network node, e.g., eNB 2, while using the ProSe in the idle state, and the UE that transmits signals may decide to request reconfiguration of resources for the ProSe and release of the radio resources configured by the eNB 1 or release of context. Three methods as described in blocks 1006-1010, blocks 1011-1014 and blocks 1015-1019 respectively may be adopted to request the network to release the resources. The procedure in block 1020 is performed after the procedures of any of the three methods are performed.

At block 1006, the UE that transmits signal sends a ProSe resources reconfiguration request to the current serving eNB, i.e., eNB 2, specifying the identity or the address of the eNB 1 that configured the resources for the ProSe of UE.

The UE may also specify the identity of the UE, the identity of the ProSe, or the identity of the radio resources.

If the radio resources are shared by a group of UEs that transmit signals, the first UE may also specify the identity of the UE group when requesting the eNB to release the radio resources.

At block 1007, the eNB 2 obtains ProSe context of the UE from the eNB 1, and reconfigures resources for the ProSe. The request may include the identity of the UE, the identity of a UE group, the identity of the ProSe, or the identity of the radio resources.

The identity of the UE may be a GUTI, an IMSI, an S-TMSI, or a C-RNTI. The eNB 2 may send the request to the eNB 1 via an S1 interface or an X2 interface.

At block 1008, the eNB 2 instructs the eNB 1 to release the radio resources configured to the UE for the ProSe or the ProSe context of the UE. The eNB 1 releases the resources configured by the eNB 1 to the UE for the ProSe according to the request of the eNB 2, and deletes the proximity-based context of the UE.

For group-specific resources, after receiving a resources release request or a context release request sent by a member of the UE group, the radio network node may delete the UE context of the member while preserving the resources configured to the UE group for the ProSe. When a resources release request or a context release request sent by the last member of the UE group is received, the radio network node releases the radio resources configured to the UE group for the ProSe.

At block 1009, the eNB 2 sends a resources update notification to an MME indicating the radio resources of the ProSe of the UE has been updated to be the resources configured by the eNB 2. The eNB 2 may also specify the reason for the resources release. The MME may decide whether to release ProSe context of the first UE or perform resources re-allocation according to the reason for the resources release.

At block 1010, the MME forwards the resources update notification to the ProSe function. The MME may also specify the reason for the resources release. The ProSe function may decide whether to release ProSe context of the first UE or perform resources re-allocation according to the reason for the resources release.

After this procedure, the first method of the UE directly requesting an eNB to reconfigure resources is completed, and the procedure in block 1020 may be performed. The following is the second method where the UE requests the eNB to reconfigure resources via an MME.

At block 1011, the UE sends a ProSe resources reconfiguration request to the MME, specifying the identity or the address of the eNB 1 that configured the resources, and may further specify the identity of the UE, the identity of the ProSe, or the identity of the radio resources.

If the radio resources are shared by a group of UEs that transmit signals, the first UE may also specify the identity of the UE group when requesting the MME to release the radio resources.

The first UE may also specify the identity of the radio resources or the identity of the eNB to which the radio resources belong.

At block 1012, the MME requests an eNB 2 to configure resources required by the ProSe according to the request of the UE.

At block 1013, the MME sends a resources release request or a UE context release request to the eNB 1 according to the request of the UE.

The eNB 1 releases the resources of the ProSe according to the request of the MME, and deletes the ProSe context of the UE.

At block 1014, the MME sends a resources update notification to the ProSe function.

The MME may also specify the reason for the resources release. The ProSe function may decide whether to release ProSe context of the first UE or perform resources reallocation according to the reason for the resources release.

After this procedure, the second method where the UE requesting an eNB to reconfigure resources via an MME is completed, and the procedure in block 1020 may be performed. The following is the third method where the UE requests the eNB to reconfigure resources via an MME and a ProSe function.

At block 1015, the UE sends a ProSe resources reconfiguration request to the ProSe function, specifying the identity or the address of the eNB 1 that configured the resources, and may further specify the identity of the UE, the identity of the ProSe, or the identity of the radio resources. The UE may also specify the identity or the address of the eNB 2 which is requested to re-configure radio resources for the ProSe of the UE.

If the radio resources are shared by a group of UEs that transmit signals, the first UE may also specify the identity of the UE group when requesting the ProSe function to release the radio resources.

The first UE may also specify the identity of the radio resources of the ProSe or the identity of the eNB to which the radio resources belong.

The first UE may also specify the identity of the MME to which the ProSe belongs.

At block 1016, the ProSe function sends a resources reconfiguration request to the MME, indicating the radio resources for the ProSe of the UE have been switched from the eNB 1 to the eNB 2. The MME may be the MME that is serving the first UE, or the MME specified by the first UE.

The ProSe function may also specify the identity of the radio resources of the ProSe of the first UE or the identity of the eNB 1 to which the radio resources belong.

At block 1017, the MME requests an eNB 2 to configure resources required by the ProSe according to the request of the UE.

At block 1018, the MME sends a resources release request to the eNB 1. The eNB may be the eNB that is serving the first UE, or the eNB specified by the ProSe function. The eNB 1 releases the resources of the ProSe according to the request of the MME, and deletes the ProSe context of the UE.

At block 1019, the MME sends a resources reconfiguration response to the ProSe function indicating that the resources have been reconfigured by the eNB 2.

After this procedure, the third method where the UE requesting an eNB to reconfigure resources via an MME is completed, and the procedure in block 1020 may be performed.

At block 1020, the eNB may update monitor configurations of UEs that are monitoring signals and are within the coverage of the eNB so that the UEs may choose not to monitor the released radio resources of the ProSe.

The eNB may also inform adjacent eNBs to update monitor configurations of UEs within respective coverage.

After this procedure, the method for maintenance and release of UE resources of example eight is completed. In block 1020 it is mentioned that the eNB may instruct neighboring eNBs to update monitor configurations of UEs in respective coverage. In order to implement update of monitor configurations across neighboring eNBs, neighboring eNBs may store radio resources configured by each other to respective UEs and monitor configurations of each other, and configure UEs that monitor signals and are within respective coverage. The process may be similar to that described in example two.

The above described several examples of the method for maintenance and release of UE resources. The present disclosure also provide a radio network node device, a terminal device and a core network device for implementing the above methods.

FIG. 11 is a schematic diagram illustrating a basic structure of a radio network node apparatus in accordance with an example of the present disclosure. As shown in FIG. 11, the radio network node device may include a resources release initiating module 1101 and a resources releasing module 1102.

in the radio network node device, the resources release initiating module 1101 is configured to instruct the resources releasing module 1102 to release resources according to a radio resources release request sent by a UE that is transmitting signals in a ProSe or according to an instant state of the UE. The resources releasing module 1102 is configured to release radio resources configured to the UE for the ProSe or delete ProSe context of the UE after receiving a trigger signal from the resources release initiating module 1101. The ProSe is a ProSe direct discovery service or a ProSe direct communication service.

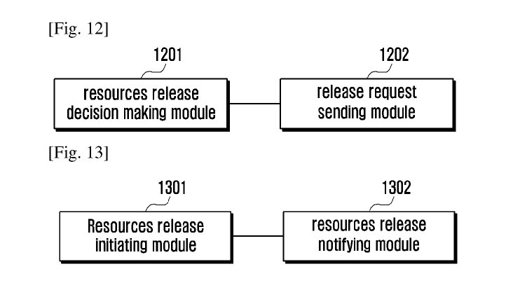

FIG. 12 is a schematic diagram illustrating a basic structure of a terminal device in accordance with an example of the present disclosure. As shown in FIG. 12, the terminal device may include a resources release decision making module 1201 and a release request sending module 1202.

In the terminal device, the resources release decision making module 1201 is configured to inform the release request sending module 1202 when a ProSe is terminated or radio resources for the ProSe is inactivated; The release request sending module 1202 is configured to instruct a radio network node that configured the resources to release radio resources for a terminated or de-activated ProSe after receiving a resource release notification sent by the resources release decision making module 1201. The ProSe is a ProSe direct discovery service or a ProSe direct communication service.

FIG. 13 is a schematic diagram illustrating a basic structure of a core network node device in accordance with an example of the present disclosure. As shown in FIG. 13, the core network node device may include a resources release initiating module 1301 and a resources release notifying module 1302.

in the core network node device, the resources release initiating module 1301 is configured to instruct the resources release notifying module 1302 to release resources according to a radio resources release request sent by a UE that is transmitting signals in a ProSe or according to an instant state of the UE. The resources release notifying module 1202 is configured to instructs a radio network node that configured radio resources to the UE for the ProSe directly or via a core network node or via a core network node and a ProSe function to release the radio resources after receiving a triggering signal sent by the resources release initiating module 1301. The ProSe is a ProSe direct discovery service or a ProSe direct communication service; when the UE informs the radio network node indirectly, a radio resources release request sent by the UE includes an identity or an address of the radio network node.

According to the above technical mechanisms, the method and apparatus of the present disclosure enables correct release of radio resources configured to a UE or a group of UEs for a ProSe, and solves the problem of maintenance of ProSe context of UEs. The technical mechanisms provide different solutions regarding resources releasing, state updating, resources switching, monitor configurations updating. The present disclosure provides flexible solutions for ProSe direct discovery services, provide users with diversified network experiences, and can meet requirements for communication services involving public safety and social networking.

The foregoing are only preferred examples of the present disclosure and are not for use in limiting the protection scope thereof. All modifications, equivalent replacements or improvements in accordance with the spirit and principles of the present disclosure shall be included in the protection scope of the present disclosure.

1.-14. (canceled)

15. A method for releasing radio resources by a user equipment (UE), the method comprising:
establishing a proximity-based service (ProSe) of the UE;
generating sidelink UE information to request release of radio resources for the ProSe; and
transmitting, to a base station, the sidelink UE information.

16. The method of claim 15, wherein the ProSe of the UE is a ProSe direct discovery service or a ProSe direct communication service.

17. The method of claim 16, wherein the sidelink UE information indicates that the UE does not require the radio resources for the ProSe direct discovery service.

18. The method of claim 16, wherein the sidelink UE information indicates that the UE does not require the radio resources for the ProSe direct communication service.

19. The method of claim 15, wherein the sidelink UE information includes an identity of the radio resources for the ProSe.

20. The method of claim 16, wherein the sidelink UE information includes a destination which is identified by an identity of the UE group associated with the ProSe.

21. A user equipment (UE) for releasing radio resources, the UE comprising:
a transceiver for transmitting and receiving a signal; and
a controller for establishing a proximity-based service (ProSe) of the UE, generating sidelink UE information to request release of radio resources for the ProSe, and transmitting, to a base station, the sidelink UE information.

22. The UE of claim 21, wherein the ProSe of the UE is a ProSe direct discovery service or a ProSe direct communication service.

23. The UE of claim 22, wherein the sidelink UE information indicates that the UE does not require the radio resources for the ProSe direct discovery service.

24. The UE of claim 22, wherein the sidelink UE information indicates that the UE does not require the radio resources for the ProSe direct communication service.

25. The UE of claim 21, wherein the sidelink UE information includes an identity of the radio resources for the ProSe.

26. The UE of claim 21, wherein the sidelink UE information includes a destination which is identified by an identity of the UE group associated with the ProSe.

27. A method for releasing radio resources by a base station, the method comprising:
identifying radio resources required for a proximity-based service (ProSe) of a user equipment (UE);
transmitting, to the UE, information on the radio resources required for the ProSe; and
receiving, from the UE, sidelink UE information to request release of the radio resources for the ProSe.

28. The method of claim 27, wherein the ProSe of the UE is a ProSe direct discovery service or a ProSe direct communication service.

29. The method of claim 27, wherein the sidelink UE information includes an identity of the radio resources for the ProSe.

30. The method of claim 27, wherein the sidelink UE information includes a destination which is identified by an identity of the UE group associated with the ProSe.

31. A base station for releasing radio resources of a user equipment (UE), the base station comprising:
a transceiver for transmitting and receiving a signal; and
a controller for identifying radio resources required for a proximity-based service (ProSe) of the UE, transmitting, to the UE, information on the radio resources required for the ProSe, and receiving, from the UE, sidelink UE information to request release of the radio resources for the ProSe.

32. The base station of claim 31, wherein the ProSe of the UE is a ProSe direct discovery service or a ProSe direct communication service.

33. The base station of claim 31, wherein the sidelink UE information includes an identity of the radio resources for the ProSe.

34. The base station of claim 31, wherein the sidelink UE information includes a destination which is identified by an identity of the UE group associated with the ProSe.
